(19) United States
(12) Patent Application Publication
(10) Pub. No.: US 2026/0208547 A1
(43) Pub. Date: Jul. 23, 2026

(54) SUSPENSION APPARATUS FOR DRIVING TEST

(71) Applicant: KOOKMIN UNIVERSITY INDUSTRY ACADEMY COOPERATION FOUNDATION, Seoul (KR)

(72) Inventors: Jay Il JEONG, Seoul (KR); Do Hyun KIM, Seoul (KR)

(21) Appl. No.: 19/142,314

(22) PCT Filed: Sep. 26, 2023
(86) PCT No.: PCT/KR2023/014727

§ 371 Date: Jun. 23, 2025

(30) Foreign Application Priority Data
Dec. 27, 2022 (KR) 10-2022-0185992

(51) Int. Cl. B60G 15/02; B60G 3/12; B60T 1/06

(52) U.S. Cl. CPC B60G 15/02; B60G 3/12; B60T 1/065

(57) ABSTRACT

The present disclosure relates to a suspension apparatus that is installed on a robot driving body for a driving test to absorb shocks from a driving surface. A suspension apparatus for a driving test according to one embodiment of the present disclosure may include a wheel exposed downward from a bottom surface of the robot driving body and configured to rotate about a wheel shaft and to roll on the driving surface, a swing arm configured to extend laterally, with one end rotatably connected to the wheel shaft and the other end pivotally connected to a first portion of the robot driving body, an auxiliary link including a first auxiliary link shaft at one end pivotally connected to a central portion of the swing arm, and a second auxiliary link shaft provided at the other end, a main link including a first point, a second point, and a third point arranged to define a triangular shape, the second auxiliary link shaft being pivotally connected at the first point, a second point shaft provided at the second point and pivotally connected to a second portion of the robot driving body, and a third point shaft provided at the third point, and a suspension configured to elastically deform in a lateral direction, with one end pivotally connected to the third point shaft and the other end pivotally connected to a third portion of the robot driving body.

### TECHNICAL FIELD

The present disclosure relates to a suspension apparatus for a driving test, and more particularly, to a suspension apparatus for a driving test that is installed on a robot driving body for a driving test to absorb shocks from a driving surface.

### BACKGROUND

A vehicle is a convenient means of transportation. However, serious injury and property damage may occur when an accident such as a collision happens. Accordingly, technologies for preventing vehicle accidents by using a collision prevention system have been actively developed.

The collision prevention system may prevent a collision in advance or reduce damage from the collision by appropriately controlling vehicle driving when another vehicle approaches or various collision signs are detected.

Accordingly, the collision prevention system is a highly effective means for protecting lives and property, and thus its reliability is of utmost importance. Since the collision prevention system performs its functions in extreme situations such as collisions between vehicles, there are limitations in testing its performance by ordinary users. Therefore, the system must be released only after a certain level of reliability has been secured through appropriate testing during installation and production.

Accordingly, developing a proper test evaluation system capable of testing and evaluating such a collision prevention system is very important. In particular, since vehicle driving conditions may vary widely, it is necessary to develop a test evaluation system for the collision prevention system that enables testing to be conducted under environments corresponding to actual driving conditions.

However, during the test evaluation process of the collision prevention system, unexpected accidents may occur. Thus, it is also important to prevent increases in test costs due to driver injuries and vehicle damage during testing of vehicles equipped with collision avoidance systems.

Accordingly, there is a need for test equipment capable of reproducing situations similar to actual driving conditions while preventing driver injuries and increased test costs. For this reason, a robot driving body for a driving test, similar to an actual vehicle, has been developed and used for testing.

In such a robot driving body for a driving test, each component may be arranged within a limited design space, and it is particularly important to ensure an appropriate structural design under height constraints.

In particular, in the case of an existing suspension apparatus installed in the robot driving body to absorb shocks from the driving surface, a swing arm-type suspension, a suspension directly connected to a shock absorber, or a suspension mechanism relying solely on the cushioning effect of the tires has been used, in order to absorb shocks and ensure driving stability within the limited design space of the robot driving body.

However, when driving is required not in an indoor environment but on a public road or rough terrain, smooth shock absorption by the shock absorber may be difficult due to a limited stroke, and it is challenging to drive over potholes or cracks on the road. In addition, when stiffness of the shock absorber is increased to enhance impact absorption, a natural frequency of the robot driving body increases, which may make it difficult to achieve smooth driving.

Accordingly, to enable more diverse and effective testing, the suspension apparatus for a driving test installed in the robot driving body may be appropriately designed. However, the existing suspension apparatus for a driving test may have limitations in appropriately implementing such a structure.

### PRIOR ART DOCUMENT

Korean Patent Application Publication No. 10-2017-0022648 (Published on Mar. 2, 2017)

### DISCLOSURE

### Technical Problem

The present disclosure is directed to solving the above issues associated with existing suspension apparatuses for a driving test.

The present disclosure is directed to providing a suspension apparatus for a driving test that may be easily installed in a robot driving body, which has constraints on design height, by converting vertical displacement into horizontal displacement.

In addition, the present disclosure is directed to providing a suspension apparatus for a driving test that may improve design flexibility of a robot driving body and reduce constraints on design height, by dispersing vertical displacement of a mechanism in a specific direction based on the positions and relative angular relationship of connection points.

Aspects of the present disclosure are not limited to the above-mentioned aspects, and other technical aspects not mentioned above will be clearly understood by those skilled in the art from the following description.

### Technical Solution

An aspect of the present disclosure may provide a suspension apparatus for a driving test, installed on a robot driving body for a driving test to absorb shocks from a driving surface, the suspension apparatus including: a wheel exposed downward from a bottom surface of the robot driving body and configured to rotate about a wheel shaft and to roll on the driving surface; a swing arm configured to extend laterally, with one end rotatably connected to the wheel shaft and the other end pivotally connected to a first portion of the robot driving body; an auxiliary link including a first auxiliary link shaft at one end pivotally connected to a central portion of the swing arm, and a second auxiliary link shaft provided at the other end; a main link including a first point, a second point, and a third point arranged to define a triangular shape, a second point shaft provided at the second point and pivotally connected to a second portion of the robot driving body, and a third point shaft provided at the third point, the second auxiliary link shaft being pivotally connected at the first point; and a suspension configured to elastically deform in a lateral direction, with one end pivotally connected to the third point shaft and the other end pivotally connected to a third portion of the robot driving body.

The swing arm may be symmetrically coupled to both lateral sides of the wheel.

The auxiliary link may be symmetrically coupled to both lateral sides of the main link.

The suspension may include a damper rod configured to be extendable and contractible between the third point shaft and the third portion of the robot driving body, a spring made of an elastic material and disposed along a longitudinal direction on an outer circumferential surface of the damper rod, and a spring seat configured to press one end of the spring upon compression of the damper rod.

The suspension apparatus for a driving test may further include a brake configured to restrict rotation of the wheel about the wheel shaft. The brake may include a disc fixed to and rotating with the wheel shaft, and a friction pad configured to generate frictional force by contacting the disc.

The suspension apparatus for a driving test may further include a swing arm holder configured to cover a portion of the wheel shaft and to be coupled to the one end of the swing arm. The wheel shaft may be configured to be separable from the one end of the swing arm upon separation of the swing arm holder from the swing arm.

Another aspect of the present disclosure may provide a suspension apparatus for a driving test, installed on a robot driving body for a driving test to absorb shocks from a driving surface, the suspension apparatus including: a wheel exposed downward from a bottom surface of the robot driving body and configured to rotate about a wheel shaft and to roll on the driving surface; a swing arm configured to extend laterally with one end rotatably connected to the wheel shaft and the other end pivotally connected to a first portion of the robot driving body; an auxiliary link including a first auxiliary link shaft at one end pivotally connected to a central portion of the swing arm, and a second auxiliary link shaft provided at the other end; a main link including a first point, a second point, and a third point arranged to define a triangular shape, a second point shaft provided at the second point and pivotally connected to a second portion of the robot driving body, and a third point shaft provided at the third point, the second auxiliary link shaft being pivotally connected at the first point; a dual link having one end pivotally connected to the third point shaft and including a dual link shaft provided at the other end; a suspension link having a fourth point, a fifth point, and a sixth point arranged to define a triangular shape, a fifth point shaft provided at the fifth point and pivotally connected to a third portion of the robot driving body, and a sixth point shaft provided at the sixth point, the dual link shaft being pivotally connected at the fourth point; and a suspension configured to elastically deform in a lateral direction, with one end pivotally connected to the sixth point shaft and the other end pivotally connected to a fourth portion of the robot driving body.

The swing arm may be symmetrically coupled to both lateral sides of the wheel.

The auxiliary link may be symmetrically coupled to both lateral sides of the main link.

The suspension may include a damper rod configured to be extendable and contractible between the sixth point shaft and the fourth portion of the robot driving body, a spring made of an elastic material and disposed along a longitudinal direction on an outer circumferential surface of the damper rod, and a spring seat configured to press one end of the spring upon compression of the damper rod.

The suspension apparatus for a driving test may further include a brake configured to restrict rotation of the wheel about the wheel shaft. The brake may include a disc fixed to and rotating with the wheel shaft, and a friction pad configured to generate frictional force by contacting the disc.

The suspension apparatus for a driving test may further include a swing arm holder configured to cover a portion of the wheel shaft and to be coupled to the one end of the swing arm. The wheel shaft may be configured to be separable from the one end of the swing arm upon separation of the swing arm holder from the swing arm.

Technical solutions of the present disclosure are not limited to the above-mentioned technical solutions, and other technical solutions not mentioned above will be clearly understood by those skilled in the art from the following description.

### BRIEF DESCRIPTION OF THE DRAWINGS

FIGS. 1 and 2 are diagrams exemplarily illustrating a robot driving body on which a suspension apparatus for a driving test according to one embodiment of the present disclosure is installed.

FIGS. 3 and 4 are diagrams illustrating a suspension apparatus for a driving test according to one embodiment of the present disclosure.

FIGS. 5 and 6 are diagrams schematically illustrating an operating state of a suspension apparatus for a driving test according to one embodiment of the present disclosure.

FIG. 7 is a diagram illustrating a process in which a wheel is separated from a suspension apparatus for a driving test according to one embodiment of the present disclosure.

FIGS. 8 and 9 are diagrams illustrating a suspension apparatus for a driving test according to another embodiment of the present disclosure.

FIGS. 10 and 11 are diagrams schematically illustrating an operating state of a suspension apparatus for a driving test according to another embodiment of the present disclosure.

FIGS. 12 and 13 are diagrams experimentally illustrating a reaction force of a wheel with respect to stroke in a suspension apparatus for a driving test according to another embodiment of the present disclosure.

### DETAILED DESCRIPTION

Hereinafter, embodiments disclosed the present disclosure will be described in detail with reference to the accompanying drawings, and the same or similar components are denoted by the same reference, and repeated description thereof will be omitted. Further, such as “module” and a “unit”, suffixes for components used in the following description are given or mixed and used by considering easiness in preparing a specification and do not have a meaning or role distinguished from each other in themselves. In describing the embodiment disclosed in the present specification, when it is determined that a detailed description of a related publicly known technology may obscure the gist of the embodiment disclosed in the present specification, the detailed description thereof will be omitted. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

A singular form may include a plural form if there is no clearly opposite meaning in the context.

In the present disclosure, it should be understood that terminology “include” or “have” indicates that a feature, a number, a step, an operation, a component, a part or the combination thereof described in the specification is present, but do not preclude the presence or addition of one or more other features, numbers, steps, operations, components, parts or combinations.

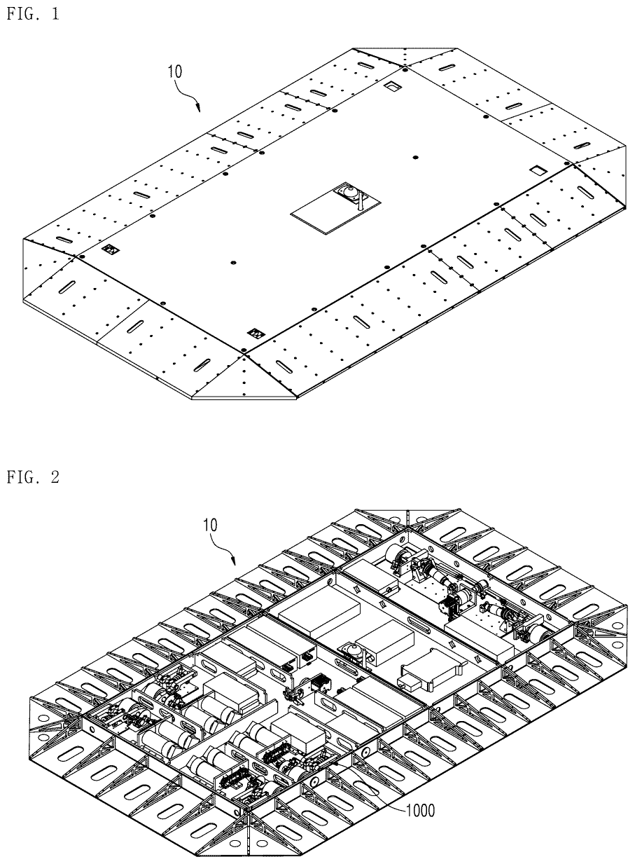

FIGS. 1 and 2 are diagrams exemplarily illustrating a robot driving body 10 on which a suspension apparatus 1000 for a driving test according to one embodiment of the present disclosure is installed.

A suspension apparatus 1000 for a driving test according to one embodiment of the present disclosure may be installed on a robot driving body 10 for a driving test to absorb shocks from a driving surface.

The robot driving body 10 for a driving test may include a main body and an inclined skirt disposed to surround an outer side of the main body. When an actual driving test is performed using the robot driving body 10, a vehicle-shaped outer shell may be placed over the outside of the robot driving body 10.

The main body may include a driving module configured to perform driving, a communication module configured to communicate with an external communication device to exchange signals, and a base frame having a mounting space to accommodate the driving module and the communication module.

In addition to the driving module and the communication module, the base frame may further accommodate a processing module including a computing device configured to execute specific operations and a sensor device configured to detect various types of signals, and the like.

As described above, various modules and devices need to be installed in the robot driving body 10 for a driving test. However, since the robot driving body 10 may be manufactured to be relatively smaller than an actual vehicle, there may be a constraint in that each component must be efficiently arranged within a limited design space.

In particular, considering cases where the vehicle-shaped outer shell may be placed over the outside of the robot driving body 10, it is necessary to reduce the design height of the robot driving body 10, and thus there is a clear limitation in the available design space.

Accordingly, the structure of the suspension apparatus 1000 for a driving test needs to be designed to appropriately achieve shock absorption and driving stability within a limited design height.

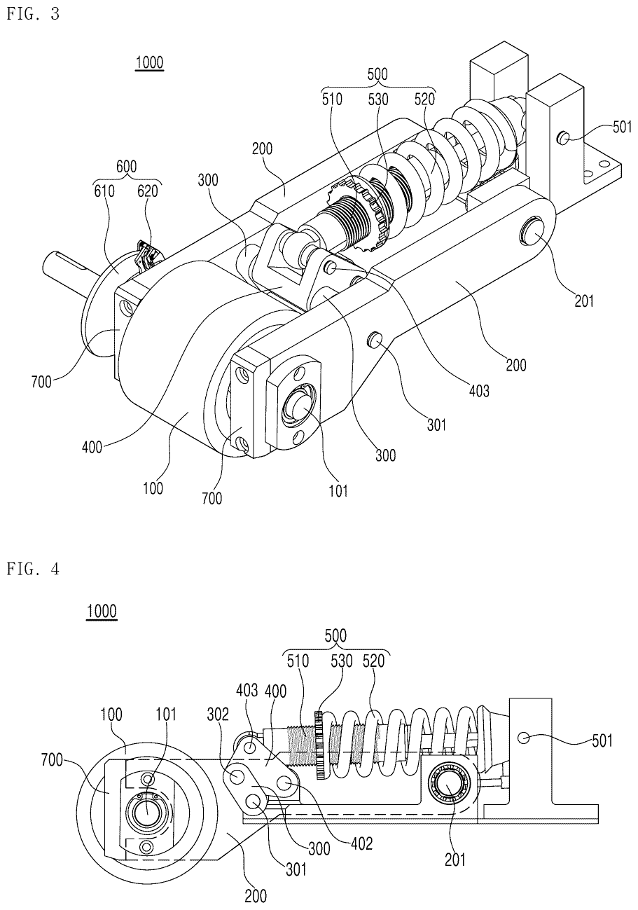

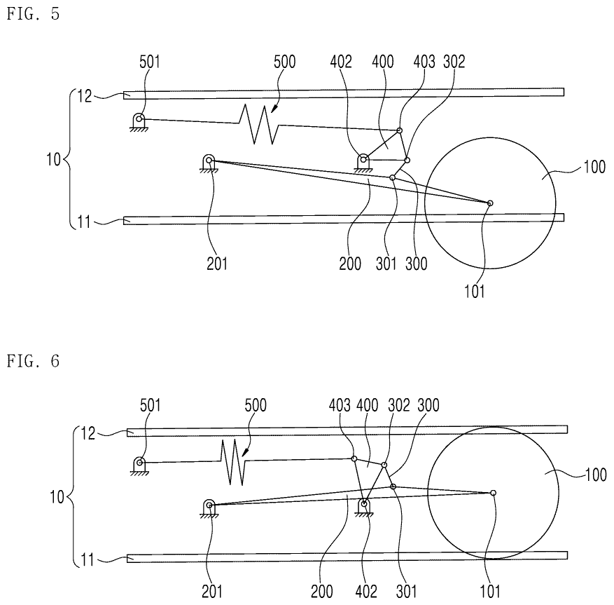

FIGS. 3 and 4 are diagrams illustrating a suspension apparatus 1000 for a driving test according to one embodiment of the present disclosure. FIGS. 5 and 6 are diagrams schematically illustrating an operating state of a suspension apparatus 1000 for a driving test according to one embodiment of the present disclosure.

In connection with the foregoing, a suspension apparatus 1000 for a driving test according to one embodiment of the present disclosure may include a wheel 100, a swing arm 200, an auxiliary link 300, a main link 400, and a suspension 500.

The wheel 100 may be configured to be exposed downward from a bottom surface 11 of a robot driving body, to rotate about a wheel shaft 101, and to roll on a driving surface.

Specifically, as illustrated in FIGS. 3 and 4, the wheel 100 may be formed as a rotatable member and may be configured to move the robot driving body 10 by rolling on the driving surface. The wheel 100 may be mounted in the mounting space of the robot driving body 10 and may be exposed downward through a wheel hole formed in the bottom surface 11 of the robot driving body.

The wheel 100 may be configured to be displaceable in a vertical direction relative to the bottom surface 11 of the robot driving body, so that shocks from the driving surface may be absorbed. Vertical displacement of the wheel 100 may be achieved by deformation of the remaining components of the suspension apparatus 1000 for a driving test. The displacement of the wheel 100 may not necessarily be limited to the vertical direction and may include forward, backward, and lateral directions.

The swing arm 200 may be configured to extend laterally. One end of the swing arm 200 may be pivotally connected to the wheel shaft 101, and a swing arm shaft 201 at the other end may be pivotally connected to a first portion of the robot driving body 10.

Specifically, as illustrated in FIGS. 3 and 4, the swing arm 200 may have a predetermined length in a lateral direction, with the wheel shaft 101 connected at one end and the swing arm shaft 201 connected at the other end. The wheel 100 may be connected to the wheel shaft 101, and the swing arm shaft 201 may be connected to the first portion of the robot driving body 10.

Accordingly, the swing arm 200 may connect the robot driving body 10 and the wheel 100, and may support the wheel 100 with respect to the robot driving body 10. Since the swing arm 200 may pivot about the swing arm shaft 201, the wheel 100 connected at one end of the swing arm 200 may be displaceable in a vertical direction relative to the bottom surface 11 of the robot driving body.

According to the above-described structure, when the wheel 100 installed on the robot driving body 10 receives upward force from the driving surface, the swing arm 200 may pivot upward about the swing arm shaft 201.

The auxiliary link 300 may include a first auxiliary link shaft 301 at one end pivotally connected to a central portion of the swing arm 200, and a second auxiliary link shaft 302 installed at the other end.

Specifically, as illustrated in FIGS. 3 and 4, the first auxiliary link shaft 301 may be connected at one end of the auxiliary link 300, and the second auxiliary link shaft 302 may be connected at the other end. The first auxiliary link shaft 301 may be connected to a central portion of the swing arm 200, and the second auxiliary link shaft 302 may be connected to the main link 400.

Accordingly, the auxiliary link 300 may connect the swing arm 200 and the main link 400, thereby transmitting displacement of the swing arm 200 to the main link 400.

As described above, when the swing arm 200 pivots upward about the swing arm shaft 201, the auxiliary link 300 may also pivot about the first auxiliary link shaft 301. In this case, the auxiliary link 300 may also move upward together with the swing arm 200, thereby transmitting a portion of the displacement of the swing arm 200 in a vertical direction. However, through pivot motion of the auxiliary link 300, the displacement of the swing arm 200 may also be partially transmitted in a lateral direction.

The main link 400 may include a first point, a second point, and a third point arranged to define a triangular shape. The second auxiliary link shaft 302 may be pivotally connected at the first point, a second point shaft 402 at the second point may be pivotally connected to a second portion of the robot driving body 10, and a third point shaft 403 may be provided at the third point.

Specifically, as illustrated in FIGS. 3 and 4, the main link 400 may be formed to have a first point, a second point, and a third point, each connected to a different component, and the first point, the second point, and the third point may define a triangular shape.

In the main link 400, the second auxiliary link shaft 302 may be pivotally connected at the first point, the second point shaft 402 may be pivotally connected at the second point, and the third point shaft 403 may be pivotally connected at the third point. The second auxiliary link shaft 302 may be connected to the auxiliary link 300, the second point shaft 402 may be connected to a second portion of the robot driving body 10, and the third point shaft 403 may be connected to the suspension 500. The second portion of the robot driving body 10 refers to a portion that may be separate from the first portion of the robot driving body 10.

Accordingly, the main link 400 may connect the auxiliary link 300 and the suspension 500, thereby transmitting displacement of the auxiliary link 300 to the suspension 500.

When an upward displacement of the swing arm 200 is transmitted to the auxiliary link 300, the first point of the main link 400 may be elevated to some extent together with the auxiliary link 300. However, since the main link 400 may be connected to the second portion of the robot driving body 10 at the second point, the main link 400 may not be elevated as a whole, but may instead pivot about the second point shaft 402. Accordingly, vertical displacement transmitted through the auxiliary link 300 may be converted into horizontal displacement by pivoting of the main link 400.

The suspension 500 may be configured to elastically deform in a lateral direction from one end pivotally connected by the third point shaft 403, and the other end may be pivotally connected to a third portion of the robot driving body 10 via a suspension shaft 501.

Specifically, as illustrated in FIGS. 3 and 4, the suspension 500 may have a predetermined length in a lateral direction. The third point shaft 403 may be connected at one end, and the suspension shaft 501 may be connected at the other end. The third point shaft 403 may be pivotally connected to the main link 400, and the suspension shaft 501 may be pivotally connected to the third portion of the robot driving body 10. The third portion of the robot driving body 10 refers to a portion that may be separate from the first portion and the second portion of the robot driving body 10.

Accordingly, the suspension 500 may connect the main link 400 and the robot driving body 10, and may support the main link 400 with respect to the robot driving body 10.

When an upward displacement of the swing arm 200 is transmitted to the auxiliary link 300 and causes the main link 400 to pivot, a third point of the main link 400 may press the suspension 500 in a lateral direction. The suspension 500 may absorb and relieve force by being elastically deformed along a lateral direction.

According to the above-described structure, when the wheel 100 installed on the robot driving body 10 receives upward force from the driving surface, the force may be transmitted to the suspension 500 through the swing arm 200, the auxiliary link 300, and the main link 400. In particular, during the process of force transmission, vertical displacement may be converted into horizontal displacement.

Accordingly, the suspension apparatus 1000 for a driving test installed on the robot driving body 10 may be installed without requiring a relatively large height space.

As such, in the suspension apparatus 1000 for a driving test according to one embodiment of the present disclosure, force applied when the wheel 100 comes into contact with a driving surface may be transmitted to the triangular main link 400. As the main link 400 pivots, the force may be transmitted to the suspension 500, so that vertical displacement may be converted into horizontal displacement. Accordingly, the suspension apparatus 1000 for a driving test may be easily installed on the robot driving body 10 even under constraints in design height.

Hereinafter, an operating mechanism of the suspension apparatus 1000 for a driving test according to one embodiment of the present disclosure will be described with reference to FIGS. 5 and 6.

The wheel 100 may come into contact with the driving surface and may transmit external disturbances to the robot driving body 10. The wheel shaft 101 may serve as a rotational joint between the wheel 100 and the swing arm 200. The swing arm shaft 201, the second point shaft 402, and the suspension shaft 501 may serve as fixed points of the swing arm 200, the main link 400, and the suspension 500, respectively, and may function as pivot points for each component.

The wheel shaft 101, which may be coupled to the center of the wheel 100, may rotate about the swing arm shaft 201, which serves as a fixed point, in response to an external load. In connection with this, the first auxiliary link shaft 301 may also pivot about the swing arm shaft 201, and a tangential displacement along a circular path may be transmitted to the second auxiliary link shaft 302 through the auxiliary link 300.

In this process, the second auxiliary link shaft 302, the second point shaft 402, and the third point shaft 403, which are located on the main link 400, may move as follows. The second auxiliary link shaft 302 may pivot while maintaining a relative angular relationship with the wheel shaft 101, and accordingly, the third point shaft 403 may also pivot by an amount of the angular displacement of the second auxiliary link shaft 302.

Such pivot motion may convert vertical displacement of the suspension apparatus 1000 for a driving test into horizontal displacement, and may also amplify displacement of an input shaft of the mechanism and transmit it in the horizontal direction. The pivot motion of the third point shaft 403 may transmit contractive displacement to the suspension 500 in the horizontal direction, thereby inducing contraction of the suspension 500. Accordingly, the wheel 100 of the robot driving body 10 may experience a reaction force caused by contraction of the suspension 500.

In the suspension apparatus 1000 for a driving test according to one embodiment of the present disclosure, the swing arm 200 may be configured to be symmetrically coupled to both lateral sides of the wheel 100. That is, as illustrated in FIGS. 3 and 4, the swing arm 200 may be configured to be symmetrically coupled to both ends of the wheel shaft 101. The wheel shaft 101 may penetrate the wheel 100 and be coupled thereto.

As described above, in order to convert vertical displacement into horizontal displacement, it is necessary for the force transmission structure to be stably implemented. If deformation such as torsion occurs in a specific component due to the force applied to the wheel 100, vertical displacement may not be properly converted into horizontal displacement.

Therefore, it may be desirable to allow a pair of symmetrically arranged swing arms 200 to support both lateral sides of the wheel 100 in a balanced manner with respect to the robot driving body 10, so that deformation such as torsion may not occur during the process of force transmission.

The suspension apparatus 1000 for a driving test according to one embodiment of the present disclosure may include the swing arms 200 symmetrically coupled to both lateral sides of the wheel 100, so that the force transmission process may be balanced and the inherent functionality may be properly exhibited.

In the suspension apparatus 1000 for a driving test according to one embodiment of the present disclosure, the auxiliary link 300 may be configured to be symmetrically coupled to both lateral sides of the main link 400. That is, as illustrated in FIGS. 3 and 4, the auxiliary links 300 may be symmetrically coupled to both ends of the second auxiliary link shaft 302, which may penetrate and be coupled to the main link 400.

As described above, in order to convert vertical displacement into horizontal displacement, it is necessary for the force transmission structure to be stably implemented.

Therefore, it may be desirable to allow a pair of symmetrically arranged auxiliary links 300 to transmit force in a balanced manner to both sides of the main link 400, so that deformation such as torsion may not occur during the process of force transmission.

The suspension apparatus 1000 for a driving test according to one embodiment of the present disclosure may include the auxiliary links 300 symmetrically coupled to both lateral sides of the main link 400, so that the force transmission process may be balanced and the inherent functionality may be properly exhibited.

In the suspension apparatus 1000 for a driving test according to one embodiment of the present disclosure, the suspension 500 may include a damper rod 510, a spring 520, and a spring seat 530.

The damper rod 510 may be configured to be extendable and contractible between the third point shaft 403 and a third portion of the robot driving body 10. The damper rod 510 may have a predetermined length in a lateral direction, and may be extendable or compressible based on pivoting of the main link 400.

The spring 520 may be made of an elastic material and may be configured to be installed along a longitudinal direction on an outer circumferential surface of the damper rod 510. That is, the spring 520 may be wound around an outer circumferential surface of the damper rod 510, and a portion thereof may be constrained by deformation of the damper rod 510. When the damper rod 510 is extended or compressed based on pivoting of the main link 400, a restoring force may be applied to the damper rod 510 by the elasticity of the spring 520.

The spring seat 530 may be configured to press one end of the spring 520 when the damper rod 510 is contracted. That is, the spring seat 530 may be coupled to a portion of the damper rod 510 and may transmit deformation of the damper rod 510 to the spring 520. Therefore, when the damper rod 510 is compressed based on pivoting of the main link 400, the spring seat 530 may press the spring 520, and the elasticity of the compressed spring 520 may act as a restoring force on the damper rod 510 through the spring seat 530.

As described above, the suspension apparatus 1000 for a driving test according to one embodiment of the present disclosure may more effectively absorb and reduce shocks through the suspension 500, which may include the damper rod 510, the spring 520, and the spring seat 530.

A suspension apparatus 1000 for a driving test according to one embodiment of the present disclosure may further include a brake 600 configured to restrict rotational motion of the wheel 100 about the wheel shaft 101. The brake 600 may include a disc 610 and a friction pad 620.

The disc 610 may be fixed to the wheel shaft 101 and may rotate together with the wheel shaft 101, and the friction pad 620 may be configured to contact the disc 610 to generate frictional force. When the friction pad 620 contacts the disc 610, rotation of the disc 610 may be restricted by frictional force, and rotation of the wheel shaft 101 coupled to the disc 610 may also be restricted.

When a predetermined signal is applied by a user, the friction pad 620 may contact the disc 610 to generate frictional force, and accordingly, rotation of the wheel shaft 101 and the wheel 100 may be decelerated or stopped.

As described above, the suspension apparatus 1000 for a driving test according to one embodiment of the present disclosure may include the brake 600 including the disc 610 and the friction pad 620, which allows the brake 600 to have a relatively simple structure while effectively reducing the speed of the robot driving body 10 when needed.

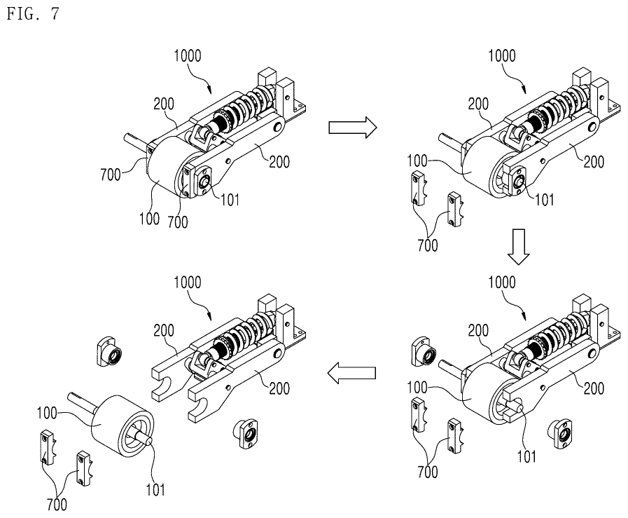

FIG. 7 is a diagram illustrating a process in which a wheel 100 may be separated from a suspension apparatus 1000 for a driving test according to one embodiment of the present disclosure.

The suspension apparatus 1000 for a driving test according to one embodiment of the present disclosure may further include a swing arm holder 700 configured to cover a portion of the wheel shaft 101 and to be coupled to one end of the swing arm 200. The wheel shaft 101 may be detachable from one end of the swing arm 200 when the swing arm holder 700 is detached from the swing arm 200.

As illustrated in FIG. 7, the swing arm holder 700 may be detachably coupled to one end of the swing arm 200. The swing arm holder 700 may be configured to be coupled to the swing arm 200 and to prevent the wheel shaft 101 from being separated from the swing arm 200.

In contrast, when the swing arm holder 700 is detached from the swing arm 200, a portion covering the wheel shaft 101 may be opened, and the wheel shaft 101 may be separated from the swing arm 200.

When replacement or inspection of the wheel 100 is required, the wheel 100 may be separated from the swing arm 200 by detaching only the swing arm holder 700 from the swing arm 200 without disassembling the swing arm 200.

As described above, the suspension apparatus 1000 for a driving test according to one embodiment of the present disclosure may allow the wheel 100 to be separated simply by detaching the swing arm holder 700 from the swing arm 200, thereby facilitating replacement or inspection of the wheel 100.

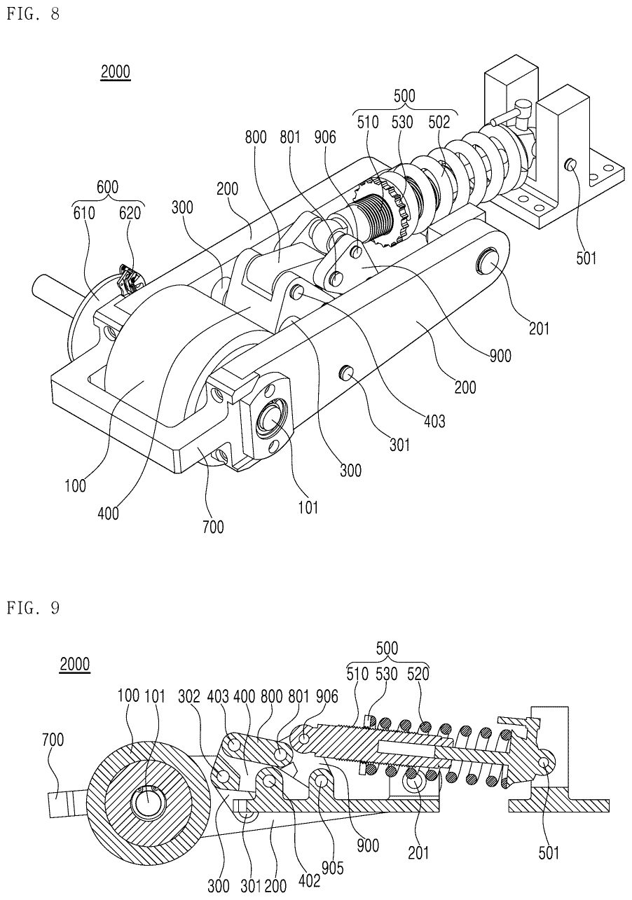

Meanwhile, as illustrated in FIG. 3, the swing arm holder 700 may be formed as a pair of separate components, each coupled to a corresponding swing arm 200. Alternatively, as illustrated in FIG. 8, the swing arm holder 700 may be formed as an integrated structure connecting both swing arms 200.

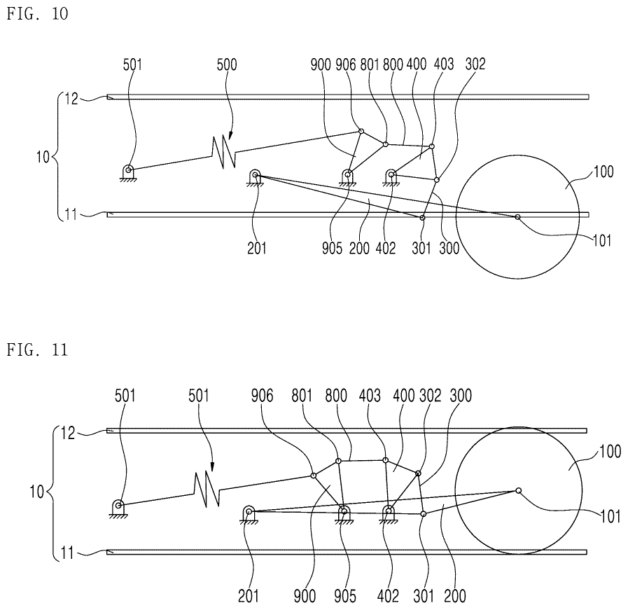

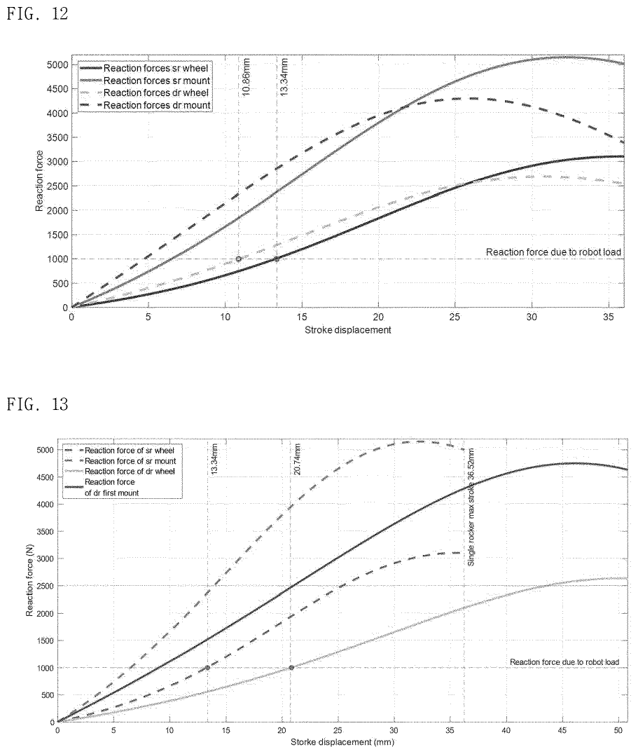

FIGS. 8 and 9 are diagrams illustrating a suspension apparatus 2000 for a driving test according to another embodiment of the present disclosure. FIGS. 10 and 11 are diagrams schematically illustrating an operating state of a suspension apparatus 2000 for a driving test according to another embodiment of the present disclosure. FIGS. 12 and 13 are diagrams experimentally illustrating a reaction force of the wheel 100 with respect to stroke in a suspension apparatus 2000 for a driving test according to another embodiment of the present disclosure.

A suspension apparatus 2000 for a driving test according to another embodiment of the present disclosure may also be installed on a robot driving body 10 for a driving test to absorb shocks from a driving surface.

In connection with the foregoing, a suspension apparatus 2000 for a driving test according to another embodiment of the present disclosure may include a wheel 100, a swing arm 200, an auxiliary link 300, a main link 400, a dual link 800, a suspension link 900, and a suspension 500.

The wheel 100 may be configured to be exposed downward from a bottom surface 11 of a robot driving body, to rotate about a wheel shaft 101, and to roll on a driving surface.

The swing arm 200 may be configured to extend laterally. One end of the swing arm 200 may be pivotally connected to the wheel shaft 101, and a swing arm shaft 201 at the other end may be pivotally connected to a first portion of the robot driving body 10.

The auxiliary link 300 may include a first auxiliary link shaft 301 at one end pivotally connected to a central portion of the swing arm 200, and a second auxiliary link shaft 302 installed at the other end.

The main link 400 includes a first point, a second point, and a third point arranged to define a triangular shape. The second auxiliary link shaft 302 may be pivotally connected at the first point, a second point shaft 402 at the second point may be pivotally connected to a second portion of the robot driving body 10, and a third point shaft 403 may be provided at the third point.

Specifically, as illustrated in FIGS. 8 and 9, the main link 400 may be formed to have a first point, a second point, and a third point, each connected to a different component, and the first point, the second point, and the third point may define a triangular shape.

In the main link 400, the second auxiliary link shaft 302 may be pivotally connected at the first point, the second point shaft 402 may be pivotally connected at the second point, and the third point shaft 403 may be pivotally connected at the third point. The second auxiliary link shaft 302 may be connected to the auxiliary link 300, the second point shaft 402 may be connected to a second portion of the robot driving body 10, and the third point shaft 403 may be connected to the dual link 800.

Accordingly, the main link 400 may connect the auxiliary link 300 and the dual link 800, thereby transmitting displacement of the auxiliary link 300 to the dual link 800.

When an upward displacement of the swing arm 200 is transmitted to the auxiliary link 300, the first point of the main link 400 may be elevated to some extent together with the auxiliary link 300. However, since the main link 400 may be connected to the second portion of the robot driving body 10 at the second point, the main link 400 may not be elevated as a whole, but may instead pivot about the second point shaft 402. Accordingly, vertical displacement transmitted through the auxiliary link 300 may be converted into horizontal displacement by pivoting of the main link 400.

In the suspension apparatus 1000 for a driving test according to one embodiment of the present disclosure as described above, displacement of the main link 400 may be directly transmitted to the suspension 500. However, in the suspension apparatus 2000 for a driving test according to another embodiment of the present disclosure, displacement of the main link 400 may be converted once more into horizontal displacement through the dual link 800 and the suspension link 900 before being transmitted to suspension 500.

The dual link 800 may be a portion where the third point shaft 403 may be pivotally connected at one end and the dual link shaft 801 may be installed at the other end.

Specifically, as illustrated in FIGS. 8 and 9, the third point shaft 403 may be connected at one end of the dual link 800, and the dual link shaft 801 may be connected at the other end thereof. The third point shaft 403 may be connected to the main link 400, and the dual link shaft 801 may be connected to the suspension link 900.

Accordingly, the dual link 800 may be configured to connect the main link 400 and the suspension link 900, and may be configured to transmit displacement of the main link 400 to the suspension link 900.

The suspension link 900 may include a fourth point, a fifth point, and a sixth point arranged to define a triangular shape. A dual link shaft 801 may be pivotally connected at the fourth point, a fifth point shaft 905 at the fifth point may be pivotally connected to a third portion of the robot driving body 10, and a sixth point shaft 906 may be provided at the sixth point.

Specifically, as illustrated in FIGS. 8 and 9, the suspension link 900 may be formed to have a fourth point, a fifth point, and a sixth point, each connected to a different component, and the fourth point, the fifth point, and the sixth point may define a triangular shape.

The suspension link 900 may be pivotally connected at the fourth point to the dual link shaft 801, and may include the fifth point shaft 905 and the sixth point shaft 906 pivotally connected at the fifth and sixth points, respectively. The dual link shaft 801 may be connected to the dual link 800, the fifth point shaft 905 may be connected to a third portion of the robot driving body 10, and the sixth point shaft 906 may be connected to the suspension 500.

Accordingly, the suspension link 900 may connect the dual link 800 and the suspension 500, thereby transmitting displacement of the dual link 800 to the suspension 500.

As described above, displacement transmitted by the pivoting of the main link 400 may be transmitted to the suspension link 900 through the dual link 800, and the suspension link 900 may be pivotally rotated about the fifth point shaft 905. Accordingly, the displacement transmitted through the dual link 800 may be converted once more into horizontal displacement by the pivoting of the suspension link 900.

The suspension 500 may be configured to elastically deform in a lateral direction from one end pivotally connected by the sixth point shaft 906, and the other end may be pivotally connected to a fourth portion of the robot driving body 10 via a suspension shaft 501.

Specifically, as illustrated in FIGS. 8 and 9, the suspension 500 may have a predetermined length in a lateral direction. The sixth point shaft 906 may be connected at one end, and the suspension shaft 501 may be connected at the other end. The sixth point shaft 906 may be pivotally connected to the suspension link 900, and the suspension shaft 501 may be pivotally connected to the fourth portion of the robot driving body 10. The fourth portion of the robot driving body 10 refers to a portion that may be separate from the first portion, the second portion and the third portion of the robot driving body 10.

Accordingly, the suspension 500 may connect the suspension link 900 and the robot driving body 10, and may support the suspension link 900 with respect to the robot driving body 10.

When the suspension link 900 pivots, a sixth point of the suspension link 900 may apply a lateral force to the suspension 500. The suspension 500 may absorb and relieve force by being elastically deformed along a lateral direction.

According to the above-described structure, when the wheel 100 installed on the robot driving body 10 receives upward force from the driving surface, the force may be transmitted to the suspension 500 through the swing arm 200, the auxiliary link 300, the main link 400, the dual link 800 and the suspension link 900. In particular, during the process of force transmission, vertical displacement may be converted into horizontal displacement.

Accordingly, the suspension apparatus 2000 for a driving test installed on the robot driving body 10 may be installed without requiring a relatively large height space.

As such, in the suspension apparatus 2000 for a driving test according to one embodiment of the present disclosure, force applied when the wheel 100 comes into contact with a driving surface may be transmitted to the triangular main link 400 and the suspension link 900. As the main link 400 and the suspension link 900 pivot, the force may be transmitted to the suspension 500, so that vertical displacement may be sequentially converted into horizontal displacement. Accordingly, the suspension apparatus 2000 for a driving test may be easily installed on the robot driving body 10 even under constraints in design height.

Additionally, in the suspension apparatus 2000 for a driving test according to one embodiment of the present disclosure, a triangular main link 400 and a triangular suspension link 900 may be arranged in series along a force transmission path from the wheel 100 to the suspension 500. Accordingly, since the displacement of the mechanism may be more widely dispersed relative to the vertical direction, the design flexibility of the robot driving body 10 equipped with the suspension apparatus 2000 for a driving test may be improved, and limitations related to design height may be further reduced.

Hereinafter, an operating mechanism of a suspension apparatus 2000 for a driving test according to another embodiment of the present disclosure will be described with reference to FIGS. 10 and 11.

The operating mechanism of the rotational joints from the swing arm shaft 201 to the third point shaft 403 in the suspension apparatus 2000 for a driving test according to another embodiment of the present disclosure may be regarded as substantially the same as the mechanism in the suspension apparatus 1000 for a driving test according to one embodiment of the present disclosure.

Displacement transmitted from the third point shaft 403 through the dual link 800 may induce a pivoting motion of the suspension link 900, and the displacement generated in this process may induce elastic energy in the suspension 500, which is connected to the rotational joint of the sixth point shaft 906.

As such, the suspension apparatus 2000 for a driving test according to another embodiment of the present disclosure may have a relatively more complex mechanism compared to the suspension apparatus 1000 for a driving test according to one embodiment of the present disclosure. However, the height constraint of the main link 400 is not imposed by the suspension 500, thereby providing greater design flexibility. In addition, as the constraint on height is reduced, the size of the mechanism may be increased to obtain a greater stroke.

Furthermore, the suspension link 900 may change the magnitude and direction of the displacement of the mechanism once more, thereby amplifying the displacement. This allows for a broader range of design variables to be selected in designing the natural frequency of the robot driving body 10 and the stiffness of the suspension apparatus 2000 for a driving test.

Referring to FIGS. 12 and 13, an experiment on a reaction force of the wheel 100 with respect to stroke in the suspension apparatus 2000 for a driving test according to another embodiment of the present disclosure will now be described.

Here, the graph legend “SR” (Single Rocker) refers to a case where the dual link 800 and the suspension link 900 are not included, and “DR” (Double Rocker) refers to a case where the dual link 800 and the suspension link 900 are included.

FIG. 12 illustrates comparative experimental results under the same stroke condition, based on the presence or absence of the dual link 800 and the suspension link 900 in the suspension apparatus 2000 for a driving test according to another embodiment of the present disclosure.

As illustrated in FIG. 12, under the same stroke condition, the case without the dual link 800 and the suspension link 900 exhibits a greater reaction force against the wheel 100 at the end point, and exhibits a reaction force at a higher mount point compared to the case with the dual link 800 and the suspension link 900.

Accordingly, the case with the dual link 800 and the suspension link 900 exhibits a smaller reaction force against the wheel 100 at the end point of the stroke, thereby allowing for a lower body height of the robot driving body 10.

Here, the body height of the robot driving body 10 may refer to a distance between the bottom surface 11 and the top surface 12 of the robot driving body.

FIG. 13 illustrates comparative experimental results under the maximum stroke condition, based on the presence or absence of the dual link 800 and the suspension link 900 in the suspension apparatus 2000 for a driving test according to another embodiment of the present disclosure.

As illustrated in FIG. 13, under the maximum stroke condition, the maximum reaction force at the end point of the case with the dual link 800 and the suspension link 900 is smaller than that of the case without the dual link 800 and the suspension link 900. However, as the stroke increases, the case with the dual link 800 and the suspension link 900 exhibits enhanced linearity in the input-output graph and a higher maximum reaction force.

Accordingly, in the case with the dual link 800 and the suspension link 900, an increase in stroke may lead to an increase in the body height of the robot driving body 10. The increased body height and available stroke at the stroke-neutral position may lead to improved road driving performance in test environments with rough driving conditions, such as road gaps or obstacles like gravel.

In the suspension apparatus 2000 for a driving test according to another embodiment of the present disclosure, the swing arm 200 is symmetrically coupled on both lateral sides of the wheel 100, enabling balanced force transmission and proper execution of its intended function.

In addition, in the suspension apparatus 2000 for a driving test according to another embodiment of the present disclosure, the auxiliary link 300 is symmetrically connected to both lateral sides of the main link 400, enabling balanced force transmission and proper execution of its intended function.

Further, the suspension apparatus 2000 for a driving test according to another embodiment of the present disclosure may more effectively absorb and reduce shocks through the suspension 500, which may include the damper rod 510, the spring 520, and the spring seat 530.

The damper rod 510 may be configured to be extendable and contractible between the sixth point shaft 906 and a fourth portion of the robot driving body 10. The spring 520 may be made of an elastic material and may be configured to be installed along a longitudinal direction on an outer circumferential surface of the damper rod 510. The spring seat 530 may be configured to press one end of the spring 520 when the damper rod 510 is compressed.

The suspension apparatus 2000 for a driving test according to another embodiment of the present disclosure may include the brake 600 including the disc 610 and the friction pad 620, which allows the brake 600 to have a relatively simple structure while effectively reducing the speed of the robot driving body 10 when needed.

The suspension apparatus 2000 for a driving test according to another embodiment of the present disclosure may include a swing arm holder 700 that covers a portion of the wheel shaft 101 and is coupled to one end of the swing arm 200. The wheel shaft 101 may be separable from one end of the swing arm 200 when the swing arm holder 700 is detached from the swing arm 200, thereby allowing easier replacement or inspection of the wheel 100.

Except for the above-described configuration, the suspension apparatus 2000 for a driving test according to another embodiment of the present disclosure has the same or similar main configuration as the suspension apparatus 1000 for a driving test according to one embodiment of the present disclosure, and thus, a detailed description of the overlapping content will be omitted.
Government-funded R&D project supporting the present disclosure
Project Unique ID: 20220159
Project Number: A2022-0159
Ministry: Ministry of Land, Infrastructure and Transport
Managing Agency: Korea Agency for Infrastructure Technology Advancement (KAIA)
Program Title: Autonomous Driving Technology Development and Innovation Program
Project Title: Development of Level 4+ Autonomous Vehicle Performance Evaluation Technology and Construction of Test Environment
Contribution Ratio: 1/1
Performing Institution: Industry-Academic Cooperation Foundation, Kookmin University
Research Period: Jan. 1, 2022-Dec. 31, 2022
While specific exemplary embodiments of the present disclosure are described and illustrated above, it will be apparent to those skilled in the art that various modifications and variations can be made thereto within the spirit and scope of the present disclosure. Accordingly, such modifications or variations are not to be regarded as a departure from the spirit or scope of the present disclosure, and it is intended that the present disclosure cover the modifications and variations of the present disclosure provided they come within the scope of the appended claims and their equivalents.

### INDUSTRIAL APPLICABILITY

According to at least one embodiment of the present disclosure, when a wheel comes into contact with a driving surface, a force is applied to the wheel. The applied force is transmitted to a triangular main link, which rotates and transmits the force to the suspension, thereby converting vertical displacement into horizontal displacement. Accordingly, the suspension apparatus for a driving test may be easily installed even on a robot driving body with height constraints in its design.

In addition, according to at least one embodiment of the present disclosure, a triangular main link and a triangular suspension link may be arranged in series along a force transmission path from the wheel to the suspension. Accordingly, since the displacement of the mechanism may be more widely dispersed relative to the vertical direction, the design flexibility of the robot driving body equipped with the suspension apparatus for a driving test may be improved, and limitations related to design height may be further reduced.

1. A suspension apparatus for a driving test, installed on a robot driving body for a driving test to absorb shocks from a driving surface, the suspension apparatus comprising:
a wheel exposed downward from a bottom surface of the robot driving body and configured to rotate about a wheel shaft and to roll on the driving surface;
a swing arm configured to extend laterally, with one end rotatably connected to the wheel shaft and the other end pivotally connected to a first portion of the robot driving body;
an auxiliary link comprising a first auxiliary link shaft at one end pivotally connected to a central portion of the swing arm, and a second auxiliary link shaft provided at the other end;
a main link comprising a first point, a second point, and a third point arranged to define a triangular shape, a second point shaft provided at the second point and pivotally connected to a second portion of the robot driving body, and a third point shaft provided at the third point, the second auxiliary link shaft being pivotally connected at the first point; and
a suspension configured to elastically deform in a lateral direction, with one end pivotally connected to the third point shaft and the other end pivotally connected to a third portion of the robot driving body.

2. The suspension apparatus of claim 1, wherein the swing arm is configured to be symmetrically coupled to both lateral sides of the wheel.

3. The suspension apparatus of claim 2, wherein the auxiliary link is configured to be symmetrically coupled to both lateral sides of the main link.

4. The suspension apparatus of claim 1, wherein the suspension comprises a damper rod configured to be extendable and contractible between the third point shaft and the third portion of the robot driving body, a spring made of an elastic material and disposed along a longitudinal direction on an outer circumferential surface of the damper rod, and a spring seat configured to press one end of the spring upon compression of the damper rod.

5. The suspension apparatus of claim 4, further comprising a brake configured to restrict rotation of the wheel about the wheel shaft, wherein the brake comprises a disc fixed to and rotating with the wheel shaft, and a friction pad configured to generate frictional force by contacting the disc.

6. The suspension apparatus of claim 1, further comprising a swing arm holder configured to cover a portion of the wheel shaft and to be coupled to the one end of the swing arm, wherein the wheel shaft is configured to be separable from the one end of the swing arm upon separation of the swing arm holder from the swing arm.

7. A suspension apparatus for a driving test, installed on a robot driving body for a driving test to absorb shocks from a driving surface, the suspension apparatus comprising:
a wheel exposed downward from a bottom surface of the robot driving body and configured to rotate about a wheel shaft and to roll on the driving surface;
a swing arm configured to extend laterally, with one end rotatably connected to the wheel shaft and the other end pivotally connected to a first portion of the robot driving body;
an auxiliary link comprising a first auxiliary link shaft at one end pivotally connected to a central portion of the swing arm, and a second auxiliary link shaft provided at the other end;
a main link comprising a first point, a second point, and a third point arranged to define a triangular shape, a second point shaft provided at the second point and pivotally connected to a second portion of the robot driving body, and a third point shaft provided at the third point, the second auxiliary link shaft being pivotally connected at the first point;
a dual link having one end pivotally connected to the third point shaft and comprising a dual link shaft provided at the other end;
a suspension link having a fourth point, a fifth point, and a sixth point arranged to define a triangular shape, a fifth point shaft provided at the fifth point and pivotally connected to a third portion of the robot driving body, and a sixth point shaft provided at the sixth point, the dual link shaft being pivotally connected at the fourth point; and
a suspension configured to elastically deform in a lateral direction, with one end pivotally connected to the sixth point shaft and the other end pivotally connected to a fourth portion of the robot driving body.

8. The suspension apparatus of claim 7, wherein the swing arm is configured to be symmetrically coupled to both lateral sides of the wheel.

9. The suspension apparatus of claim 8, wherein the auxiliary link is configured to be symmetrically coupled to both lateral sides of the main link.

10. The suspension apparatus of claim 7, wherein the suspension comprises a damper rod configured to be extendable and contractible between the sixth point shaft and the fourth portion of the robot driving body, a spring made of an elastic material and disposed along a longitudinal direction on an outer circumferential surface of the damper rod, and a spring seat configured to press one end of the spring upon compression of the damper rod.

11. The suspension apparatus of claim 10, further comprising a brake configured to restrict rotation of the wheel about the wheel shaft, wherein the brake comprises a disc fixed to and rotating with the wheel shaft, and a friction pad configured to generate frictional force by contacting the disc.

12. The suspension apparatus of claim 7, further comprising a swing arm holder configured to cover a portion of the wheel shaft and to be coupled to the one end of the swing arm, wherein the wheel shaft is configured to be separable from the one end of the swing arm upon separation of the swing arm holder from the swing arm.
